(19) United States
(12) Patent Application Publication
(10) Pub. No.: US 2026/0205581 A1
(43) Pub. Date: Jul. 16, 2026

(54) CROSS-COMPONENT FILTERING WITH DERIVED CROSS-COMPONENT FILTER

(71) Applicant: Tencent America LLC, Palo Alto, CA (US)

(72) Inventors: Lien-Fei CHEN, Palo Alto, CA (US); Roman CHERNYAK, Santa Clara, CA (US); Yonguk YOON, Palo Alto, CA (US); Ziyue XIANG, Palo Alto, CA (US); Yifan WANG, Palo Alto, CA (US); Shan LIU, San Jose, CA (US); Biao WANG, San Jose, CA (US)

(73) Assignee: Tencent America LLC, Palo Alto, CA (US)

(21) Appl. No.: 19/372,087

(22) Filed: Oct. 28, 2025

Related U.S. Application Data
(60) Provisional application No. 63/746,212, filed on Jan. 16, 2025.

(51) Int. Cl. H04N 19/117; H04N 19/132; H04N 19/176; H04N 19/186; H04N 19/70; H04N 19/82

(52) U.S. Cl. CPC H04N 19/117; H04N 19/132; H04N 19/176; H04N 19/186; H04N 19/70; H04N 19/82

(57) ABSTRACT

A method for video decoding includes receiving a bitstream including coded information indicating that a current chroma block is filtered with cross-component filtering. One or more cross-component filtering models are determined based on first luma samples in a current luma block that is collocated with a current chroma block and based on first chroma samples of the current chroma block. A second luma sample is obtained by filtering one of the first luma samples with a luma in-loop filter. A cross-component filtering model of the one or more cross-component filtering models is then determined based on the second luma sample. The cross-component filtering model is applied to the second luma sample to obtain a cross-component filtered value. A second chroma sample is obtained based on the cross-component filtered value and one of the first chroma samples that is collocated with the one of the first luma samples.

### RELATED APPLICATION

The present application claims the benefit of priority to U.S. Provisional Application No. 63/746,212, “CROSS-COMPONENT IN-LOOP FILTER” filed on Jan. 16, 2025, which is incorporated by reference herein in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

### SUMMARY

Aspects of the disclosure provide a method for video decoding. The method for video decoding includes receiving a bitstream including coded information indicating that a current chroma block is filtered with cross-component filtering. One or more cross-component filtering models are determined based on first luma samples in a current luma block that is collocated with a current chroma block and based on first chroma samples of the current chroma block. A second luma sample is obtained by filtering one of the first luma samples with a luma in-loop filter. A cross-component filtering model of the one or more cross-component filtering models is then determined based on the second luma sample. The cross-component filtering model is applied to the second luma sample to obtain a cross-component filtered value. A second chroma sample is obtained based on the cross-component filtered value and one of the first chroma samples that is collocated with the one of the first luma samples.

Aspects of the disclosure also provide an apparatus for video decoding. The apparatus for video decoding includes processing circuitry configured to implement any of the described methods for video decoding.

Aspects of the disclosure also provide a method for video encoding. In the method of video encoding, one or more cross-component filtering models are determined based on first luma samples in a current luma block that is collocated with a current chroma block and on first chroma samples of the current chroma block. A second luma sample is obtained by filtering one of the first luma samples with a luma in-loop filter. A cross-component filtering model from the one or more cross-component filtering models is determined based on the second luma sample. The cross-component filtering model is applied to the second luma sample to obtain a cross-component filtered value. A second chroma sample is obtained based on the cross-component filtered value and on one of the first chroma samples that is collocated with the one of the first luma samples. Coded information indicating that the current chroma block is filtered with cross-component filtering is encoded in a bitstream.

Aspects of the disclosure also provide an apparatus for video encoding. The apparatus for video encoding includes processing circuitry configured to implement any of the described methods for video encoding.

Aspects of the disclosure also provide a non-transitory computer-readable storage medium storing instructions which when executed by a processor cause the processor to perform an encoding method including: determining one or more cross-component filtering models based on first luma samples in a current luma block collocated with a current chroma block and first chroma samples of the current chroma block; obtaining a second luma sample by filtering one of the first luma samples with a luma in-loop filter; determining a cross-component filtering model of the one or more cross-component filtering models based on the second luma sample; applying the cross-component filtering model to the second luma sample to obtain a cross-component filtered value; obtaining a second chroma sample based on the cross-component filtered value and one of the first chroma samples that is collocated with the one of the first luma samples; encoding, in a bitstream, coded information indicating that the current chroma block is filtered with cross-component filtering; and transmitting the bitstream.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows examples of ALF filter shapes including a 5×5 diamond shape (left) and a 7×7 diamond shape (right) according to an aspect of the disclosure.

FIG. 5 shows an example of a cross-component alternative loop filter (CC-ALF).

FIGS. 6A-6D show examples of subsampled positions used for calculating a vertical gradient, a horizontal gradient, and diagonal gradients.

FIGS. 7A-7B show mapping relationships between a directionality and edge strengths according to aspects of the disclosure.

FIGS. 8-12 show examples of block diagrams of cross-component filtering according to an aspect of the disclosure.

FIG. 13 shows an example of a filter shape (1300) used in a CC-ALF according to an aspect of the disclosure.

FIG. 14 shows an example of a block diagram of cross-component filtering according to an aspect of the disclosure.

FIG. 15 shows a flow chart outlining a decoding process according to some aspects of the disclosure.

FIG. 16 shows a flow chart outlining a process according to an aspect of the disclosure.

FIG. 17 is a schematic illustration of a computer system in accordance with an aspect.

### DETAILED DESCRIPTION

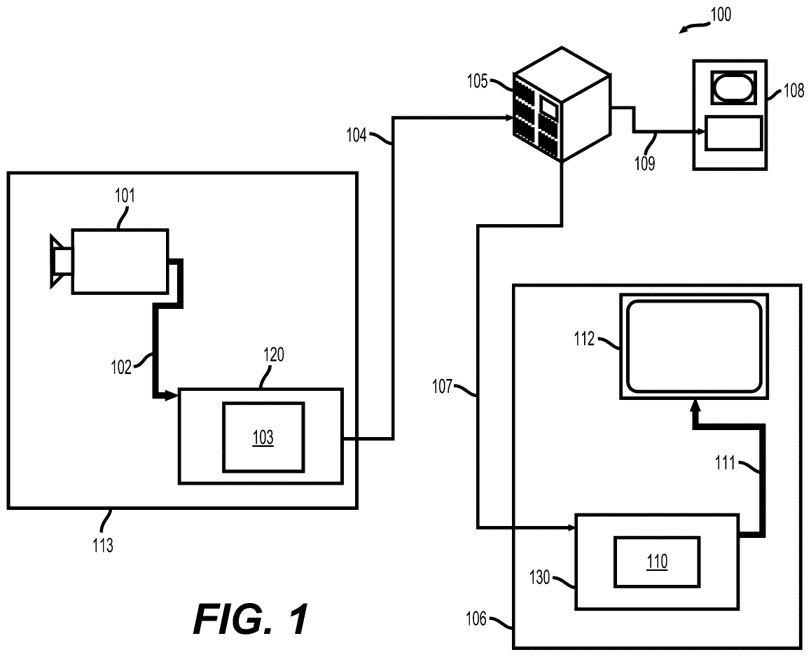

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other video enabled applications, including, for example, video conferencing, digital TV, streaming services, storing of compressed video on digital media including CD, DVD, memory stick and the like, and so on.

The video processing system (100) includes a capture subsystem (113), that may include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) may be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) may include other components (not shown). For example, the electronic device (120) may include a video decoder (not shown) and the electronic device (130) may include a video encoder (not shown) as well.

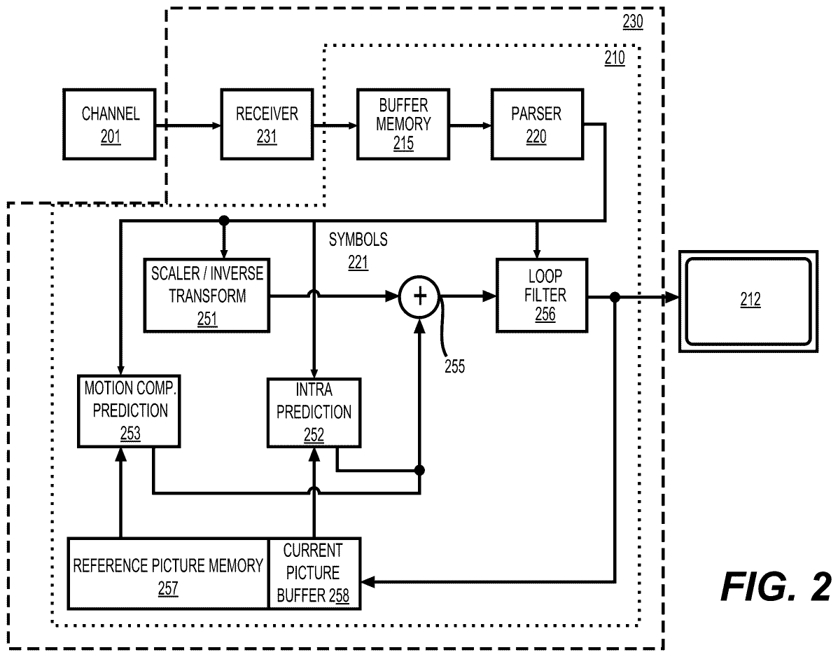

FIG. 2 shows an example of a block diagram of a video decoder (210). The video decoder (210) may be included in an electronic device (230). The electronic device (230) may include a receiver (231) (e.g., receiving circuitry). The video decoder (210) may be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it may be outside of the video decoder (210) (not depicted). In still others, there may be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or may be small. For use on best effort packet networks such as the Internet, the buffer memory (215) may be required, may be comparatively large and may be advantageously of adaptive size, and may partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but may be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence may be in accordance with a video coding technology or standard, and may follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups may include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) may involve multiple different units depending on the type of the coded video picture or parts thereof (such as: inter and intra picture, inter and intra block), and other factors. Which units are involved, and how, may be controlled by subgroup control information parsed from the coded video sequence by the parser (220). The flow of such subgroup control information between the parser (220) and the multiple units below is not depicted for clarity.

Beyond the functional blocks already mentioned, the video decoder (210) may be conceptually subdivided into a number of functional units as described below. In a practical implementation operating under commercial constraints, many of these units interact closely with each other and may, partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) may output blocks comprising sample values, that may be input into aggregator (255).

In some cases, the output samples of the scaler/inverse transform unit (251) may pertain to an intra coded block. The intra coded block is a block that is not using predictive information from previously reconstructed pictures, but may use predictive information from previously reconstructed parts of the current picture. Such predictive information may be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) may pertain to an inter coded, and potentially motion compensated, block. In such a case, a motion compensation prediction unit (253) may access reference picture memory (257) to fetch samples used for prediction. After motion compensating the fetched samples in accordance with the symbols (221) pertaining to the block, these samples may be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples may be controlled by motion vectors, available to the motion compensation prediction unit (253) in the form of symbols (221) that may have, for example X, Y, and reference picture components. Motion compensation also may include interpolation of sample values as fetched from the reference picture memory (257) when sub-sample exact motion vectors are in use, motion vector prediction mechanisms, and so forth.

The output samples of the aggregator (255) may be subject to various loop filtering techniques in the loop filter unit (256). Video compression technologies may include in-loop filter technologies that are controlled by parameters included in the coded video sequence (also referred to as coded video bitstream) and made available to the loop filter unit (256) as symbols (221) from the parser (220). Video compression may also be responsive to meta-information obtained during the decoding of previous (in decoding order) parts of the coded picture or coded video sequence, as well as responsive to previously reconstructed and loop-filtered sample values.

The output of the loop filter unit (256) may be a sample stream that may be output to the render device (212) as well as stored in the reference picture memory (257) for use in future inter-picture prediction.

Certain coded pictures, once fully reconstructed, may be used as reference pictures for future prediction. For example, once a coded picture corresponding to a current picture is fully reconstructed and the coded picture has been identified as a reference picture (by, for example, the parser (220)), the current picture buffer (258) may become a part of the reference picture memory (257), and a fresh current picture buffer may be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile may select certain tools as the only tools available for use under that profile from all the tools available in the video compression technology or standard. Also necessary for compliance may be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels may, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data may be in the form of, for example, temporal, spatial, or signal noise ratio (SNR) enhancement layers, redundant slices, redundant pictures, forward error correction codes, and so on.

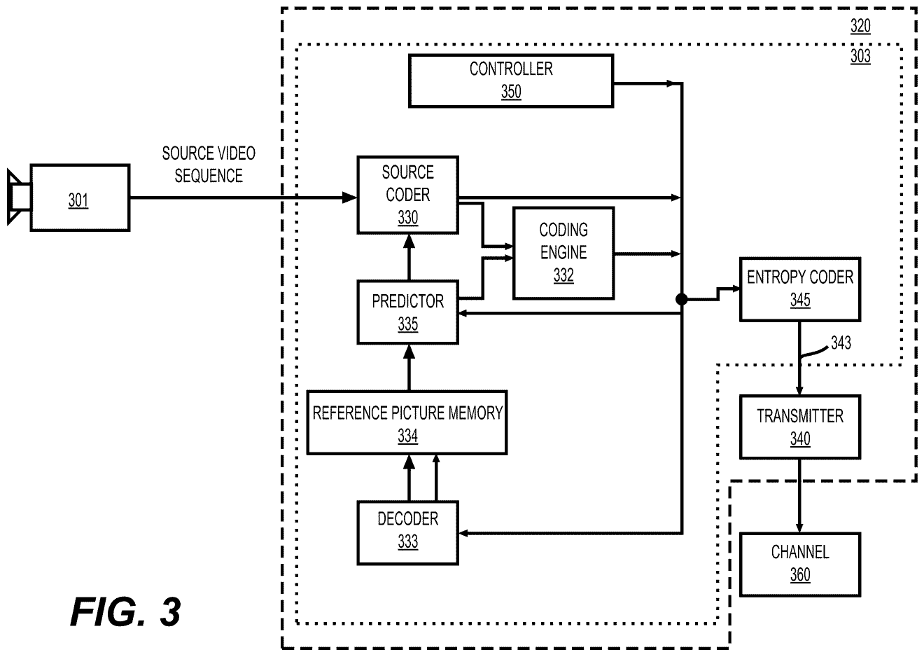

FIG. 3 shows an example of a block diagram of a video encoder (303). The video encoder (303) is included in an electronic device (320). The electronic device (320) includes a transmitter (340) (e.g., transmitting circuitry). The video encoder (303) may be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that may be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel may include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) may include rate control related parameters (picture skip, quantizer, lambda value of rate-distortion optimization techniques, . . . ), picture size, group of pictures (GOP) layout, maximum motion vector search range, and so forth. The controller (350) may be configured to have other suitable functions that pertain to the video encoder (303) optimized for a certain system design.

In some aspects, the video encoder (303) is configured to operate in a coding loop. As an oversimplified description, in an example, the coding loop may include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) may be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies may be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures may use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture may be coded by a vector that is referred to as a motion vector. The motion vector points to the reference block in the reference picture, and may have a third dimension identifying the reference picture, in case multiple reference pictures are in use.

In some aspects, a bi-prediction technique may be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture may be coded by a first motion vector that points to a first reference block in the first reference picture, and a second motion vector that points to a second reference block in the second reference picture. The block may be predicted by a combination of the first reference block and the second reference block.

Further, a merge mode technique may be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU may be recursively quadtree split into one or multiple coding units (CUs). For example, a CTU of 64×64 pixels may be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) may be implemented using any suitable technique. In an aspect, the video encoders (103) and (303) and the video decoders (110) and (210) may be implemented using one or more integrated circuits. In another aspect, the video encoders (103) and (303), and the video decoders (110) and (210) may be implemented using one or more processors that execute software instructions.

Video coding has been widely used in many applications such as broadcasting, video recording, video streaming, and the like. Various emerging video coding standards such as H.264, H.265/HEVC, H.266/VVC, and AVI are adopted in the video applications. A hybrid video codec may include coding modules, intra prediction, inter prediction, transform coding, quantization, entropy coding, post in-loop filters, and the like.

In some examples, such as in VVC, filters may be applied sequentially to a reconstructed picture to eliminate different types of artifacts. A sample-adaptive offset (SAO) filter may be applied to attenuate ringing and banding artifacts. An adaptive loop-filter (ALF) may be applied to reduce other distortions introduced by the transform and quantization process. In an example, such as in VVC, the ALF may include two operations. The first operation may be a block-based ALF, such as the ALF with block-based filter adaption for both luma and chroma samples, and the second operation may be a cross-component alternative loop filter (CC-ALF), for example, for chroma samples only.

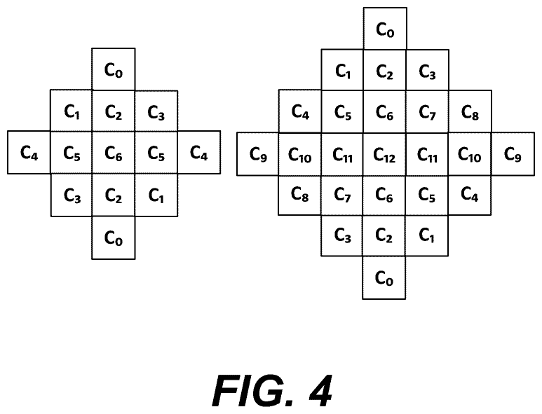

In some examples, such as in VVC, two filter shapes (e.g., two diamond filter shapes) may be used for the block-based ALF. FIG. 4 shows examples of ALF filter shapes including a 5×5 diamond shape (left) and a 7×7 diamond shape (right) according to an aspect of the disclosure. In an example, the 7×7 diamond shape is applied to a luma component, and the 5×5 diamond shape is applied to a chroma component.

In some examples, in the ALF, one among up to N1 (e.g., 25) filters may be selected for a block (e.g., a 4×4 block or each 4×4 block) based on a direction (or directionality) and an activity of local gradients. According to the directionality and the activity of the local gradient, a block (e.g., a 4×4 block) may be classified and categorized into one of N1 (e.g., 25) classes. Each class may have a respective filter coefficient assignment. Before filtering, a geometric transformation, such as 90° rotation, a diagonal flip, or a vertical flip, may be applied to a filter shape depending on gradient values calculated for the block. The geometric transformation may be equivalent to applying the geometric transformation to samples in a filter support region. The motivation for performing the geometric transformation may include performing the ALF for each block more similarly by aligning the directionality of the respective block.

In addition to a luma block-level (e.g., a 4×4 block-level) filter adaptation, a CTU-level filter adaptation may be used in the ALF. Each CTU may use a filter set calculated from a current slice, one of the filter sets signaled at already coded slices, or one of pre-defined filter sets (e.g., 16 offline trained filter sets). Within each CTU, the selected filter set may be applied to each 4×4 block. Filter coefficients and clipping indices may be carried (or signaled) in ALF adaptive parameter sets (APSs) (e.g., multiple AFL APSs). An ALF APS may include up to 8 chroma filters and one luma filter set with up to 25 filters. An index i_{c} indicating a luma filer class may be included for each of the 25 luma classes. In an example, to reduce signaling overhead, filter coefficients of different classifications for luma components may be merged. By merging different classes, a number of bits indicating filter coefficients may be reduced.

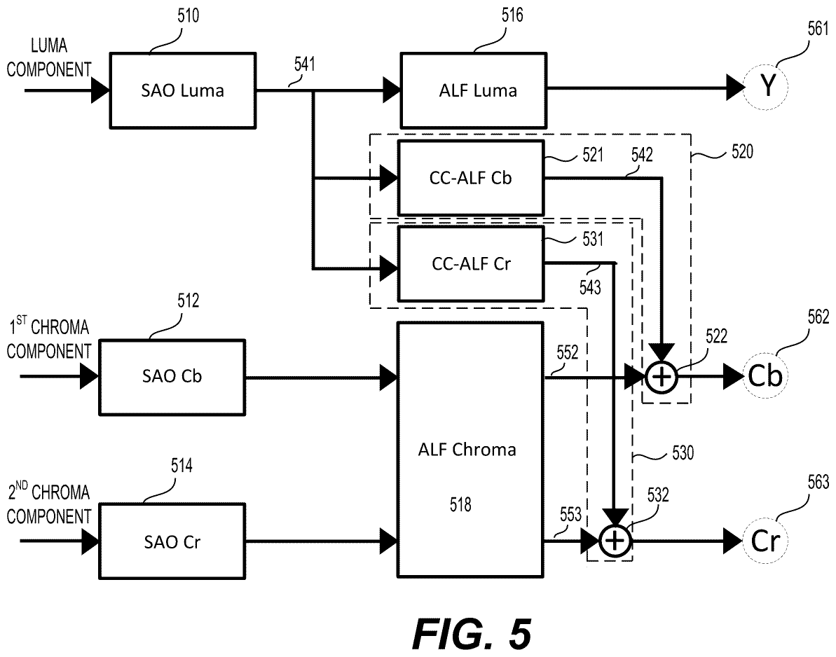

FIG. 5 shows various filters including in-loop filters according to an aspect of the disclosure. FIG. 5 shows in-loop filters for a luma component, in-loop filters for chroma components, such as cross-component filters (e.g., CC-ALFs) used to generate chroma components. In some examples, FIG. 5 shows filtering processes for a first chroma component (e.g., including first chroma input samples), a second chroma component (e.g., including second chroma input samples), and a luma component (e.g., including luma input samples). The luma component may be filtered by a SAO filter (510) to generate a SAO filtered luma component (541). The SAO filtered luma component (541) may be further filtered by an ALF luma filter (516) to become a filtered luma CB (561) (e.g., ‘Y’).

The first chroma component may be filtered by a SAO filter (512) and an ALF chroma filter (518) to generate a first intermediate component (552). Further, the SAO filtered luma component (541) may be filtered by a cross-component filter (e.g., CC-ALF) (521) for the first chroma component to generate a second intermediate component (542). Subsequently, a filtered first chroma component (562) (e.g., ‘Cb’) may be generated based on at least one of the second intermediate component (542) and the first intermediate component (552). In an example, the filtered first chroma component (562) (e.g., ‘Cb’) is generated by combining the second intermediate component (542) and the first intermediate component (552), for example, with an adder (522). The cross-component adaptive loop filtering process for the first chroma component may include a step performed by the CC-ALF (721) and a step performed by, for example, the adder (722).

The above description may be adapted to the second chroma component. The second chroma component may be filtered by a SAO filter (714) and the ALF chroma filter (518) to generate a third intermediate component (553). Further, the SAO filtered luma component (541) may be filtered by a cross-component filter (e.g., a CC-ALF) (531) for the second chroma component to generate a fourth intermediate component (543). Subsequently, a filtered second chroma component (563) (e.g., ‘Cr’) may be generated based on at least one of the fourth intermediate component (543) and the third intermediate component (553). In an example, the filtered second chroma component (563) (e.g., ‘Cr’) may be generated by combining the fourth intermediate component (543) and the third intermediate component (553), for example, with an adder (532). In an example, the cross-component adaptive loop filtering process for the second chroma component may include a step performed by the CC-ALF (531) and a step performed by, for example, the adder (532).

A cross-component filter (e.g., the CC-ALF (521), the CC-ALF (531)) may operate by applying a linear filter having any suitable filter shape to the luma component (or a luma channel) to refine each chroma component (e.g., the first chroma component, the second chroma component).

For block classification of a luma component, a 4×4 block (e.g., a luma block) may be classified as one of multiple (e.g., 25) classes, for example, using a classifier. A classification index C may be derived based on a directionality parameter D and a quantized value Â of an activity using Eq. (1).

$$2 C = 5 D + \hat{A} \qquad Eq . ( 1 )$$

To calculate the directionality parameter D and the quantized value Â, gradients gᵥ, gₕ, g_{d1}, and g_{d2} of a vertical, a horizontal, and two diagonal directions (e.g., d1 and d2), respectively, may be calculated using 1-D Laplacian as follows.

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert \qquad Eq . ( 2 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert \qquad Eq . ( 3 )$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert \qquad Eq . ( 4 )$$

$${g}_{d 2} = {\sum }_{k = i - 2}^{i + 3} {\sum }_{j = j - 3}^{j + 3} D {2}_{k , l} , D {2}_{k , l} = \vert 2 R ( k , l ) - R ( k - 1 , l + 1 ) - R ( k + 1 , l - 1 ) \vert \qquad Eq . ( 5 )$$

where indices i and j may refer to coordinates with respect to an upper left sample within the 4×4 block and R(k, l) indicates a reconstructed sample at a coordinate (k, l). The directions (e.g., d1 and d2) may refer to 2 diagonal directions.

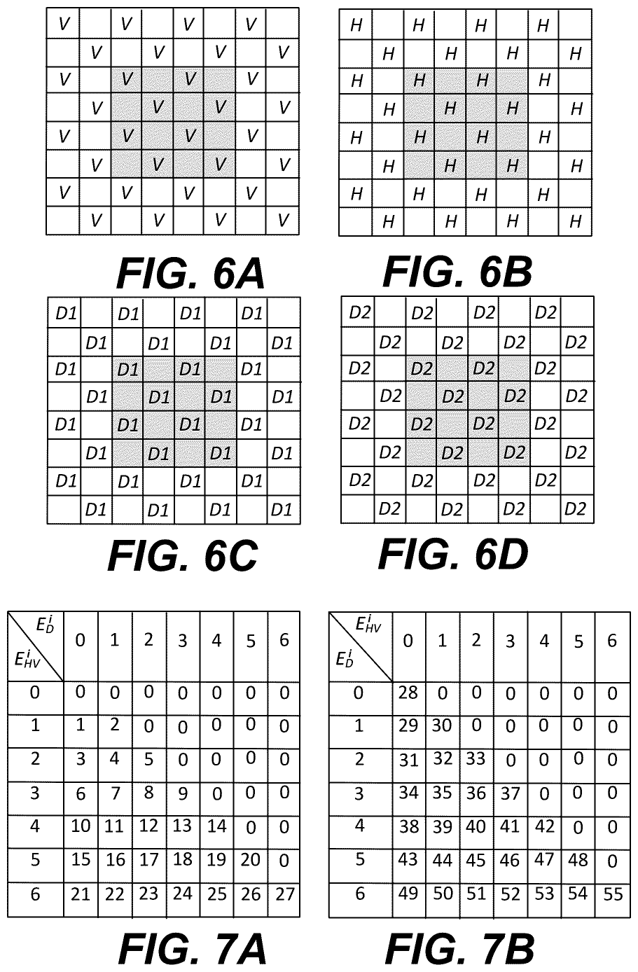

To reduce complexity of the block classification described above, a subsampled 1-D Laplacian calculation may be applied. FIGS. 6A-6D show examples of subsampled positions used for calculating the vertical gradient gᵥ (FIG. 6A), the horizontal gradient gₕ (FIG. 6B), the diagonal gradient gar (FIG. 6C), and the diagonal gradient g_{d2} (FIG. 6D), respectively. The same subsampled positions may be used for gradient calculation of the different directions. In FIG. 6A, labels ‘V’ show the subsampled positions to calculate the vertical gradient gᵥ. In FIG. 6B, labels ‘H’ show the subsampled positions to calculate the horizontal gradient gₕ. In FIG. 6C, labels ‘D1’ show the subsampled positions to calculate the d1 diagonal gradient gar. In FIG. 6D, labels ‘D2’ show the subsampled positions to calculate the d2 diagonal gradient g_{d2}.

A maximum value

$${g}_{h , v}^{max}$$

and a minimum value

$${g}_{h , v}^{min}$$

of the gradients of horizontal and vertical directions gᵥ and gₕ may be set as:

$${g}_{h , v}^{max} = max ( {g}_{h} , {g}_{v} ) , {g}_{h , v}^{min} = min ( {g}_{h} , {g}_{v} ) \qquad Eq . ( 6 )$$

A maximum value

$${g}_{d 1 , d 2}^{max}$$

and a minimum value

$${g}_{d 1 , d 2}^{min}$$

of the gradients of horizontal g_{d1} and g_{d2} may be set as:

$${g}_{d 1 , d 2}^{max} = max ( {g}_{d 1} , {g}_{d 2} ) , {g}_{d 1 , d 2}^{min} = min ( {g}_{d 1} , {g}_{d 2} ) \qquad Eq . ( 7 )$$

The directionality parameter D may be derived based on the above values and two thresholds t₁ and t₂ as below.

$$Step 1. If ( 1 ) {g}_{h , v}^{max} \leq {t}_{1} \cdot {g}_{h , v}^{min} and ( 2 ) {g}_{d 1 , d 2}^{max} \leq {t}_{1} \cdot {g}_{d 1 , d 2}^{min} are true , D is set to 0.$$

$$Step 2. If {g}_{h , v}^{max} / {g}_{h , v}^{min} > {g}_{d 1 , d 2}^{max} / {g}_{d 1 , d 2}^{min} , continue to Step 3 ; otherwise continue to Step 4.$$

$$Step 3. If {g}_{h , v}^{max} > {t}_{2} \cdot {g}_{h , v}^{min} , D is set to 2 ; otherwise D is set to 1.$$

$$Step 4. If {g}_{d 1 , d 2}^{max} > {t}_{2} \cdot {g}_{d 1 , d 2}^{min} , D is set to 4 ; otherwise D is set to 3.$$

The activity value A may be calculated as:

$$A = {\sum }_{k = i - 2}^{i + 3} {\sum }_{l = j - 2}^{j + 3} ( {V}_{k , l} + {H}_{k , l} ) \qquad Eq . ( 8 )$$

A may be further quantized to a range of 0 to 4, inclusively, and the quantized value is denoted as Â.

In an example, for chroma components in a picture, no block classification is applied, and thus a single set of ALF coefficients may be applied for each chroma component.

Geometric transformations may be applied to filter coefficients and corresponding filter clipping values (also referred to as clipping values). Before filtering a block (e.g., a 4×4 luma block), geometric transformations such as a rotation or a diagonal and a vertical flipping may be applied to the filter coefficients f(k, l) and the corresponding filter clipping values c(k, l), for example, depending on gradient values (e.g., gᵥ, gₕ, g_{d1}, and/or g_{d2}) calculated for the block. The geometric transformations applied to the filter coefficients f(k, l) and the corresponding filter clipping values c(k, l) may be equivalent to applying the geometric transformations to samples in a region supported by the filter. The geometric transformations may make different blocks to which an ALF is applied more similar by aligning the respective directionality.

Three geometric transformations, including a diagonal flip, a vertical flip, and a rotation may be performed as described by Eqs. (9)-(11), respectively.

$${f}_{D} ( k , l ) = f ( l , k ) , {c}_{D} ( k , l ) = c ( l , k ) , \qquad Eq . ( 9 )$$

$${f}_{V} ( k , l ) = f ( k , K - l - 1 ) , {c}_{V} ( k , l ) = c ( k , K - l - 1 ) \qquad Eq . ( 10 )$$

$${f}_{R} ( k , l ) = f ( K - l - 1 , k ) , {c}_{R} ( k , l ) = c ( K - l - 1 , k ) \qquad Eq . ( 11 )$$

where K is a size of the ALF or the filter, and 0≤k, l≤K−1 are coordinates of coefficients. For example, a location (0,0) is at an upper left corner and a location (K−1, K−1) is at a lower right corner of the filter f or a clipping value matrix (or clipping matrix) c. The transformations may be applied to the filter coefficients f(k, l) and the clipping values c(k, l) depending on the gradient values calculated for the block. An example of a relationship between the transformation and the four gradients are summarized in Table 1.

TABLE 1
Mapping of the gradient calculated
for a block and the transformation

| Gradient values | Transformation |
|---|---|
| g_{d2} < g_{d1} and gₕ < gᵥ | No transformation |
| g_{d2} < g_{d1} and gᵥ < gₕ | Diagonal flip |
| g_{d1} < g_{d2} and gₕ < gᵥ | Vertical flip |
| g_{d1} < g_{d2} and gᵥ < gₕ | Rotation |

In an aspect, such as in explorative compression model 5 (ECM5), ALF gradient subsampling and ALF virtual boundary processing are not used. A block size for classification may be reduced, for example, from 4×4 to 2×2. A filter size for a luma component and a chroma component, for which ALF coefficients are signaled, may be increased to 9×9 (e.g., a 9×9 diamond shape). To filter a luma sample, different classifiers such as three different classifiers C₀, C₁ and C_{A} and different sets of filters such as three different sets of filters F₀, F₁ and F_{A} may be used. The three classifiers C₀, C₁, and C_{A} may correspond to the three sets of filters F₀, F₁ and F_{A}, respectively. The sets of filters F₀ and F₁ may include fixed filters (e.g., stored in a decoder and an encoder) with coefficients trained for the classifiers C₀ and C₁. In an example, the sets of filters F₀ and F₁ are not signaled. The set of filters F_{A} may be referred to as adaptive filters. Coefficients of the set of filters F_{A} (e.g., an ALF) may be signaled. Which filter from a set (e.g., F₀, F₁, or F_{A}) is used for a given sample (or a current sample) R(x0, y0) may be determined by a class (e.g., C₀, C₁, or C_{A}) assigned to the sample using the classifier (e.g., C₀, C₁, or C_{A}). In an example, two fixed filters F₀ and F₁ (e.g., two 13×13 diamond shape fixed filters F₀ and F₁) are applied to derive two intermediate outputs, e.g., including respective intermediate samples R₀(x, y) and R₁(x, y), respectively. The filter (or the adaptive filter) F_{A} may be applied to R₀(x, y), R₁(x, y), and neighboring samples of the current sample R(x0, y0) to determine a filtered sample \tilde{R}(x0, y0) as below.

$$\tilde{R} ( x 0 , y 0 ) = R ( x 0 , y 0 ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] \qquad Eq . ( 12 )$$

where f_{i,j} (e.g., f_{i,0} or f_{i,1}) may be a difference (e.g., a clipped difference) between a neighboring sample and the current sample R(x0, y0) where i is from 0 to 19. A position of the neighboring sample corresponds to a position of the filtering coefficient cᵢ. gᵢ may be a clipped difference between Rᵢ₋₂₀(x0, y0) and the current sample R(x0, y0) where i is from 20 to 21. For example, gᵢ=clip (Rᵢ₋₂₀(x0, y0)−R(x0, y0)), and thus g₂₀=clip (R₀(x0, y0)−R(x0, y0)) and g₂₁ clip (R₁(x0, y0)−R(x0, y0)). Coefficients of the filter F_{A} may include cᵢ, i=0, . . . 21. The filter coefficients cᵢ, i=0, . . . 21, may be signalled.

In an aspect, such as ECM5, a class indicated by a classifier Cᵢ (e.g., C₀, C₁, or C_{A}) may be assigned to a block (e.g., each 2×2 block) based on a directionality (or a directionality parameter) Dᵢ and an activity Âᵢ (or a quantized value Âᵢ of an activity) as shown in Eq. (13) where i may be 0, 1, or A.

$${C}_{i} = {\hat{A}}_{i} * {M}_{D , i} + {D}_{i} \qquad Eq . ( 13 )$$

where M_{D,i} may represent a total number of directionalities Dᵢ. In an example, a class C₀ determined by Eq. (13) indicates a filter in the set of filters F₀. A class C₁ determined by Eq. (13) indicates a filter in the set of filters F₁. A class C_{A} determined by Eq. (13) indicates a filter in the set of filters F_{A}.

Similar to the description related to Eqs. (1)-(5), such as in VVC, values of a horizontal gradient

$${g}_{h}^{i} ,$$

a vertical gradient

$${g}_{v}^{i} ,$$

and two diagonal gradients

$${g}_{d 1}^{i} and {g}_{d 2}^{i}$$

may be calculated for each sample using 1-D Laplacian where i may be 0, 1, or A that correspond to the classifier C₀, C₁, or C_{A}. A sum of the sample gradients within a window (e.g., a 4×4 window) that covers the target block (e.g., the target 2×2 block) may be used for the classifier C₀ (e.g., i=0). A sum of the sample gradients within a window (e.g., a 12×12 window) may be used for the classifiers C₁ (e.g., i=1) and C_{A} (e.g., i being A). The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ may be determined by comparing

$${r}_{h , v}^{i} and {r}_{d 1 , d 2}^{i}$$

with a set of thresholds.

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} \qquad Eq . ( 14 )$$

The directionality D_{A} may be derived, for example, as in VVC using two thresholds (e.g., 2 and 4.5). For the directionalities D₀ and D1, an edge strength (e.g., a horizontal over vertical edge strength)

$${E}_{HV}^{i}$$

and an edge strength (e.g., a diagonal edge strength)

$${E}_{D}^{i}$$

may be calculated. Thresholds Th=[1.25, 1.5, 2, 3, 4.5, 8] may be used where Th[0] to Th[5] are 1.25, 1.5, 2, 3, 4.5, and 8, respectively. The edge strength

$${E}_{HV}^{i}$$

may be 0 if

$${r}_{h , v}^{i} \leq Th [ 0 ] ;$$

otherwise, the edge strength

$${E}_{HV}^{i}$$

may be the maximum integer such that

$${r}_{h , v}^{i} > Th [ {E}_{HV}^{i} - 1 ] .$$

The edge strength

$${E}_{D}^{i}$$

may be 0 if

$${r}_{d 1 , d 2}^{i} \leq Th [ 0 ] ;$$

otherwise, the edge strength

$${E}_{D}^{i}$$

may be the maximum integer such that

$${r}_{d 1 , d 2}^{i} > Th [ {E}_{D}^{i} - 1 ] .$$

### When

$${r}_{h , v}^{i} > {r}_{d 1 , d 2}^{i} ,$$

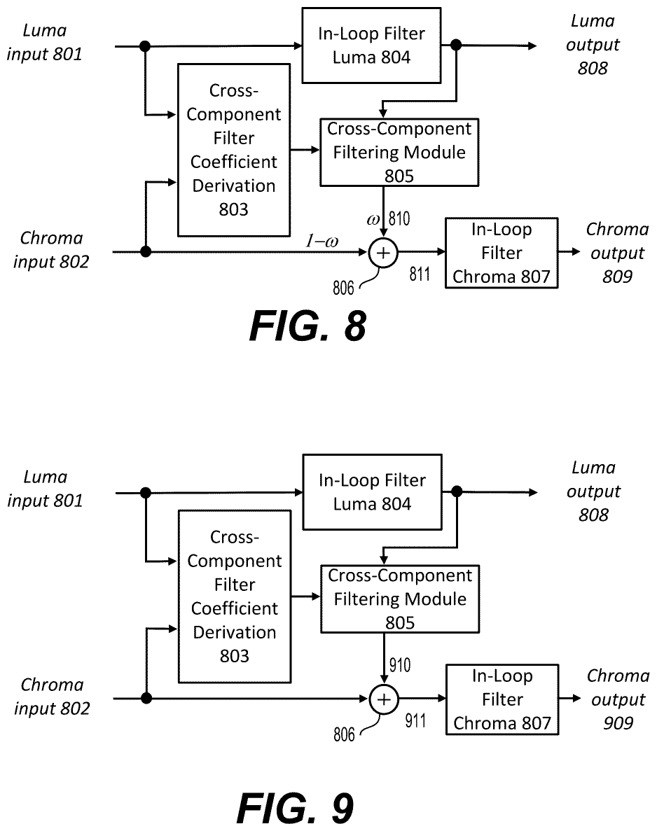

i.e., the horizontal/vertical edges are dominant, Dᵢ may be derived using FIG. 7A; otherwise,

$${r}_{h , v}^{i} \leq {r}_{d 1 , d 2}^{i}$$

the diagonal edges are dominant, Dᵢ may be derived by using FIG. 7B.

To obtain Âᵢ, a sum of vertical and horizontal gradients Aᵢ may be mapped (e.g., quantized) to a range of 0 to n, where n is equal to 4 for Â_{A} and n is equal to 15 for Â₀ and Â₁. In some examples, in an APS (e.g., an ALF_APS) that includes ALF filter coefficients, up to 4 luma filter sets may be signaled, and each set may have up to 25 filters.

The class C_{A} based on Eq. (13) and corresponding to the adaptive filter set F_{A} may be calculated based on gradients, and thus may be referred to as a gradient-based classifier. Classification in an ALF may be extended with an alternative classifier, such as a band-based classifier. For a signaled luma filter set, a flag may be signaled to indicate whether the alternative classifier (e.g., the band-based classifier) is applied. A geometrical transformation is not applied to the alternative band-based classifier. When the band-based classifier is applied, a sum of sample values of a block (e.g., a 2×2 luma block) may be calculated. The class index (or class_{index}) may be calculated using Eq. (15).

$${class}_{index} = ( sum \times 25 ) ≫ ( sample bitdepth + 2 ) \qquad Eq . ( 15 )$$

The sample bitdepth (also referred to as a sample bit depth) indicates a number of bits per sample. In an example, a class index (also denoted as class_index) such as the class index determined using Eq. (15) may indicate a filter in the adaptive filter set F_{A}.

Referring back to FIG. 5, in related technologies, the cross-component filter (521) or (531) is a filter with a set of filter coefficients. In some examples, the set of filter coefficients of the cross-component filter (521) is signaled, and is not dependent on the luma component that is input to the SAO filter (510) or the filtered luma component (541). Further, the set of filter coefficients of the cross-component filter (521) is not dependent on the first chroma component. Similarly, in some examples, the set of filter coefficients of the cross-component filter (531) is signaled, and is not dependent on the luma component that is input to the SAO filter (510) or the filtered luma component (541). Further, the set of filter coefficients of the cross-component filter (531) is not dependent on the second chroma component. Thus, in some examples, the cross-component filter (521) or (531) may not be optimal for the chroma component to be filtered.

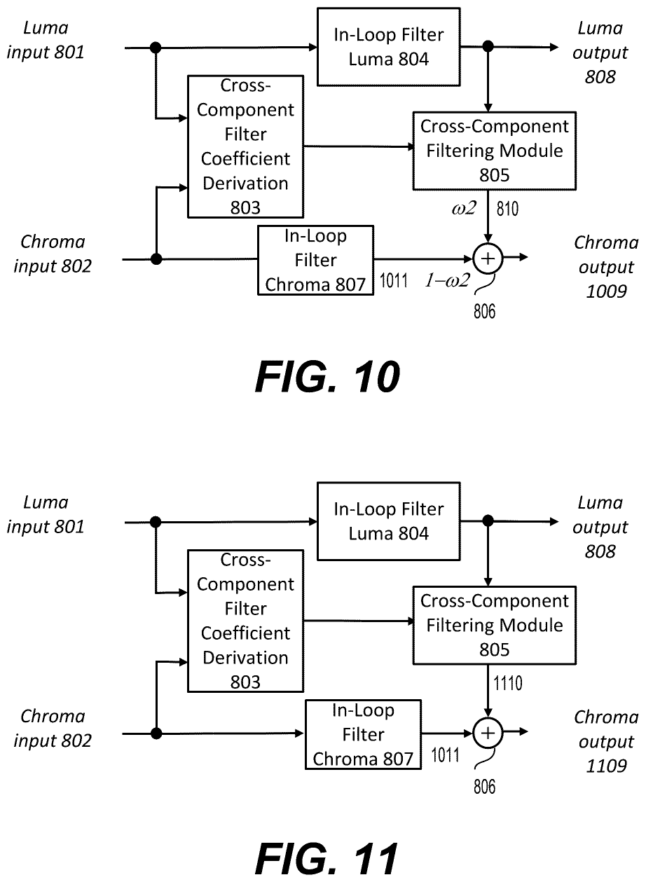

The disclosure describes methods to improve cross-component filtering, including a cross-component in-loop filter. In some examples, one or more cross-component filtering models are adaptively derived for a current chroma block based on correlations between collocated luma and chroma samples and applied using a classifier that associates luma samples to different classes. In an aspect, a cross-component filter for a chroma component (e.g., a current chroma block) to be filtered may be derived based on chroma samples in the current chroma block and luma samples in a luma component (e.g., a current luma block) that corresponds to the current chroma block. In some examples, the current luma block and the current chroma block are collocated. When the cross-component filter for the current chroma block is derived based on the chroma samples in the current chroma block and the luma samples in the current luma block, the cross-component filter indicates local characteristics of the current chroma block and the current luma block, and may be more suitable for filtering the current chroma block. Methods of deriving the cross-component filter based on the chroma samples in the current chroma block and the luma samples in the current luma block and applying the cross-component filter to filter the chroma samples are described, for example, using FIGS. 8-16, and are referred to as derivation methods.

In related technologies, in some examples, CC-ALF employs globally signaled coefficient sets, optimized over a relatively large region. The locally derived, correlation-based filter, e.g., described using FIGS. 8-16, offers multiple advantages. The filter is locally adaptive rather than globally averaged. In an example, global CC-ALF coefficients used in related technologies are an average compromise across content diversity within a relatively large region. Local derivation tailors the filter to neighborhood's statistics in a block (or a CTU), increasing per-region effectiveness. The derived filter may reduce signaling burden or improves signaling efficiency. If coefficients are derived implicitly from reconstructed samples and local correlations, explicit coefficient signaling may be reduced.

According to an aspect of the disclosure, the current chroma block is filtered with cross-component filtering. FIGS. 8-12 and 14 show examples of block diagrams of cross-component filtering according to an aspect of the disclosure. Referring to FIGS. 8-12 and 14, one or more cross-component filtering (CCF) models are determined in a cross-component filter coefficient derivation module (803). The one or more CCF models are based on first luma samples (also referred to as a luma input) (801) in the current luma block that is collocated with the current chroma block and first chroma samples (also referred to as a chroma input) (802) of the current chroma block. Second luma samples (also referred to as a luma output or luma output samples) (808) are obtained by filtering the respective first luma samples (801) with a luma in-loop filter (e.g., a luma ALF) (804). For example, a second luma sample is obtained by filtering one of the first luma samples (801) with the luma in-loop filter (804). In an example, a cross-component filtering model of the one or more cross-component filtering models is determined based on the second luma sample in a cross-component filtering module (805). In an example, in the cross-component filtering module (805), the determined cross-component filtering model is applied to the second luma sample to obtain a cross-component filtered value that is an output of the cross-component filtering module (805). Referring to FIG. 8, the cross-component filtered value is the cross-component filtered value (810) in FIG. 8. A second chroma sample is obtained based on the cross-component filtered value (e.g., (810) in FIG. 8) and one of the first chroma samples (802) collocated with the one of the first luma samples (801). Referring to FIG. 8, the second chroma sample is one of second chroma samples (also referred to as a chroma output) (809).

In an example, the first luma samples (801) in the current luma block and the first chroma samples (802) in the current chroma block are reconstructed samples that are to be filtered by a deblocking filter.

In an example, the first luma samples (801) in the current luma block and the first chroma samples (802) in the current chroma block are reconstructed samples that have been filtered by the deblocking filter.

In an example, the one or more cross-component filtering models are determined as follows: the one or more cross-component filtering models are determined by classifying the first luma samples (801) into one or more classes with a classifier in the CCF coefficient derivation module (803) in FIGS. 8-12 and 14. Each of the one or more classes corresponds to a respective cross-component filtering model of the one or more cross-component filtering models.

In an example, in the cross-component filtering module (805) in FIGS. 8-12 and 14, the cross-component filtering model is determined as follows: the second luma sample (808) is classified, with the classifier, into one of the one or more classes that corresponds to the cross-component filtering model.

In an example, the one or more classes include N2 classes, and the one or more cross-component filtering models include a plurality of cross-component filtering models. In an example, a number of the plurality of cross-component filtering models is N2.

Referring to in FIGS. 8-12 and 14, in an aspect, the one or more cross-component filtering models may be derived by using a correlation between luma input data (e.g., the luma input (801)) of an in-loop filter module (e.g., the luma in-loop filter (804)) and chroma input data (e.g., the chroma input (802)) of an in-loop filter module (e.g., the chroma in-loop filter (807)), then the cross-component filter (e.g., one of the one or more cross-component filtering models) is applied on luma output data (e.g., the luma output (808)) of the in-loop filter module (e.g., the luma in-loop filter (804)) to generate cross-component filtering output data (e.g., one of the cross-component filtering output data is the cross-component filtered value (810) shown in FIG. 8) for the chroma component. In an example, the one or more cross-component filter models are derived at a coding block or a CTU level with a classifier such as the classifier described in Eq. 1. In an example, samples are classified into multiple classes (or N2 such as 25 classes) using the classifier. Thus, N2 cross-component filter models are derived, and a number of the one or more cross-component filter models is N2. Each of cross-component filter model may be a cross-component filter having a respective set of cross-component filtering coefficients.

In an example, the classifier may be used to classify the first luma samples (801) into the N2 classes in the cross-component filter coefficient derivation module (803). In an example, the classifier is applied on each luma input sample (e.g., each first luma sample (801)) within the current luma block (e.g., a luma coding block or a CTU) to derive the associated filter coefficient set (e.g., one of the one or more cross-component filter models). In an example, a filter coefficient set corresponds to a cross-component filter and includes n-tap filter coefficients. n is a positive integer. n may be the same or may be different for two of the one or more cross-component filter models.

In an example, the classifier may be used to classify the second luma samples (808) into the N2 classes in the cross-component filtering module (805). In an example, the classifier is applied on each luma output sample (808) within the current luma block (e.g., the luma coding block or the CTU) to determine (e.g., derive) the associated filter coefficient set (e.g., one of the one or more cross-component filter models) for each luma output sample. In an example, the derived filter coefficient set (e.g., the one of the one or more CCF models) is applied on each luma output sample to obtain an output value (e.g., the cross-component filtered value (810) in FIG. 8) of the cross-component filtering module (805).

In some examples, the cross-component filtered value represents a chroma sample value that is combined with an input chroma sample via weighted blending prior to chroma in-loop filtering. In an example, referring to FIG. 8, the second chroma sample (809) is obtained as follows: a weighted average (811) of (i) the cross-component filtered value (810) with a weight ω and the one of the first chroma samples (802) with a weight (1−ω) is determined, for example, by an adder (806). The second chroma sample (809) is obtained by filtering the weighted average (811) with the chroma in-loop filter (807). For example, the filter coefficient sets derivation (e.g., the derivation of the one or more CCF models) using the classifier is based on the input samples (the first luma samples (801) and the first chroma samples (802)) of the luma in-loop filter (804) and chroma in-loop filter (807) of a whole coding block or a CTU. One of the derived filter coefficient set (e.g., the one of the one or more CCF models) is determined using the classifier and is applied to each luma output sample (808) of the luma in-loop filter (804) to obtain the chroma sample value (810). Finally, the chroma sample value (810) is blended with the chroma input (802) of the cross-component filter coefficient derivation module (803) as the input (811) of the chroma in-loop filter (807).

In the example shown in FIG. 8, the cross-component filtered value (810) is a chroma sample value, and thus the cross-component filtered value (810) is blended with the chroma input (802) using the weighted average to obtain the second chroma sample (809).

In an aspect, the cross-component filtered value represents a chroma sample offset that is added to an input chroma sample before chroma in-loop filtering. In some examples, such as shown in FIG. 9, the cross-component filtered value that is output from the cross-component filtering module (805) is a chroma sample offset value (910), and a second chroma sample (909) is obtained differently. Referring to FIG. 9, the filter coefficient sets derivation (e.g., the derivation of the one or more CCF models) using the classifier is based on the input samples (the first luma samples (801) and the first chroma samples (802)) of the luma in-loop filter (804) and chroma in-loop filter (807) of a whole coding block or a CTU. One of the derived filter coefficient set (e.g., the one of the one or more CCF models) is determined using the classifier and is applied to each luma output sample (808) of the luma in-loop filter (804) to obtain the chroma sample offset value (or the cross-component filtered value) (910). Finally, the chroma sample offset value (910) is added to the chroma input (802) of the cross-component filter coefficient derivation module (803) by the adder (806). In an example, the second chroma sample (909) is obtained as follows: the cross-component filtered value (910) is added to the one of the first chroma samples (802) by the adder (806) to obtain an intermediate chroma sample (911). The second chroma sample (909) is obtained by filtering the intermediate chroma sample (911) with the chroma in-loop filter (807).

In an aspect, the cross-component filtered value is blended with an intermediate chroma output from a chroma in-loop filter to form the final chroma sample, such as shown in FIG. 10. In an example, referring to FIG. 10, the filter coefficient sets derivation (e.g., the derivation of the one or more CCF models) using the classifier is based on the input samples (the first luma samples (801) and the first chroma samples (802)) of the luma in-loop filter (804) and chroma in-loop filter (807) of a whole coding block or a CTU. One of the derived filter coefficient set (e.g., the one of the one or more CCF models) is determined using the classifier and is applied to each luma output sample (808) of the luma in-loop filter (804) to obtain the chroma sample value (810). Finally, the chroma sample value (810) is blended with a chroma output value (also referred to as an intermediate chroma sample) (1011) of the chroma in-loop filter (807) as a final output chroma value (e.g., the second chroma sample) (1009) for the chroma component. In an example, referring to FIG. 10, the second chroma sample (1009) is obtained as follows: the intermediate chroma sample (1011) is obtained by filtering the one of the first chroma samples (802) with the chroma in-loop filter (807). A weighted average of the cross-component filtered value (810) with a weight ω2 and the intermediate chroma sample (1011) with a weight (1−ω2) is determined as the second chroma sample (1009).

In an aspect, the cross-component filtered value is added as an offset to an intermediate chroma output from a chroma in-loop filter such as shown in FIG. 11. In some examples, such as shown in FIG. 11, a cross-component filtered value that is output from the cross-component filtering module (805) is a chroma sample offset value (1110), and a second chroma sample (1109) is obtained differently than that shown in FIG. 10. Referring to FIG. 11, the filter coefficient sets derivation (e.g., the derivation of the one or more CCF models) using the classifier is based on the input samples (the first luma samples (801) and the first chroma samples (802)) of the luma in-loop filter (804) and chroma in-loop filter (807) of a whole coding block or a CTU. One of the derived filter coefficient set (e.g., the one of the one or more CCF models) is determined using the classifier and is applied to each luma output sample (808) of the luma in-loop filter (804) to obtain the chroma sample offset value (also referred to as the cross-component filtered value) (1110). Finally, the chroma sample offset value (1110) is added to the chroma output value (1011) of the chroma in-loop filter (807) to obtain a final output chroma value (e.g., the second chroma sample) (1109) for the chroma component. In an example, the second chroma sample (1109) is obtained as follows: the intermediate chroma sample (e.g., the chroma output value of the chroma in-loop filter (807)) (1011) is obtained by filtering the one of the first chroma samples (802) with the chroma in-loop filter (807), and the cross-component filtered value (1110) is added to the intermediate chroma sample (1011) by the adder (806) to obtain the second chroma sample (1109).

Referring to FIG. 12, the filter coefficient sets derivation (e.g., the derivation of the one or more CCF models) using the classifier is based on the input samples (the first luma samples (801) and the first chroma samples (802)) of the luma in-loop filter (804) and chroma in-loop filter (807) of a whole coding block or a CTU. One of the derived filter coefficient sets (e.g., the one of the one or more CCF models) is determined using the classifier and is applied to each luma output sample (808) of the luma in-loop filter (804) to obtain the chroma sample offset value (also referred to as the cross-component filtered value) (1210) for each chroma sample. In an example, the luma output samples (808) of the luma in-loop filter (804) are also input samples of a luma in-loop filter (1204). Referring to FIG. 12, the first chroma sample (802) is filtered by the chroma in-loop filter (807) to obtain the chroma output value (1011). The chroma output value (1011) is subsequently filtered by a chroma in-loop filter (1207) to obtain a chroma output value (1211). Finally, the chroma sample offset value (1210) for each chroma sample is added to the chroma output value (1211) of the chroma in-loop filter (1207) to obtain a final output value (e.g., the second chroma sample) (1209) for the chroma component. In an example, the second chroma sample (1209) is obtained as follows: an intermediate chroma sample (1211) is obtained by filtering the one of the first chroma samples (802) with a sequence of chroma in-loop filters (e.g., the chroma in-loop filters (807) and (1207)), and the cross-component filtered value (1210) is added to the intermediate chroma sample (1211) by the adder (806) to obtain the second chroma sample (1209). In an example, the second chroma sample (1209) is a sum of the cross-component filtered value (1210) and the intermediate chroma sample (1211).

Referring to FIG. 12, in an example, the input luma and chroma samples such as the first luma samples (801) and the first chroma samples (802) for the cross-component filter coefficient derivation in the cross-component filter coefficient derivation module (803) include the reconstructed samples before a deblocking filter, and thus in this case the first luma samples (801) and the first chroma samples (802) have not been deblocked. In an example, the input luma and chroma samples for the cross-component filter coefficient derivation samples such as the first luma samples (801) and the first chroma samples (802) include the reconstructed samples after the deblocking filter, and thus the first luma samples (801) and the first chroma samples (802) have been deblocked.

In an aspect, the coded information indicates activation of a cross-component filtering mode, and, where applicable, a sub-mode in which the locally derived CCF model is used. In an example, the coded information in the bitstream includes a flag indicating that the one or more cross-component filtering models are determined based on the first luma samples (801) in the current luma block and the first chroma samples (802) of the current chroma block. In an example, the flag is signaled at a coding block level, a CTU level, or the like to indicate whether the derivation method used to derive the one or more cross-component filtering models is used or not. If the flag is true, the derivation method is used to derive the one or more cross-component filtering models with the classifier and the derived filter coefficient sets with the classifier may be applied to the luma output samples (808) to improve the chroma in-loop filtering.

In an example, the classifier with multiple classes is used on luma samples to determine to which filter coefficient set a luma sample belongs. A granularity of the classifier determination may be one or more samples. The granularity of the classifier determination may be but is not limited to a sample, 2×2 samples, or the like. In an example, the classifier may be but is not limited to the classifier used in a luma ALF such as described in the disclosure. For example, the direction and variance based classifier having 25 classes that is used in the luma ALF may be used as the classifier in the cross-component filter coefficient derivation module (803) and the cross-component filtering module (805).

In an example, the classifier is one of a plurality of classifiers, and the classifier is associated with a prediction mode (e.g., inter prediction, intra prediction, intra block copy (IBC) prediction, intra template-matching (IntraTMP) prediction, or the like) of the first luma samples (801).

In an example, different classifiers are used for luma samples obtained with different prediction modes. For example, inter luma samples (also referred to as inter predicted luma samples) have corresponding first classifiers, and intra luma samples (also referred to as intra predicted luma samples) have corresponding second classifiers. The first classifiers and the second classifiers are different from each other. In this case, the first 25 classifiers are used for the inter predicted luma samples and the second 25 classifiers are used for the intra predicted luma samples when the direction and variance based classification is used. In an example, the IBC prediction block within the CTU has its own type of classifier different from the multiple classifiers used in the intra prediction and the inter prediction. In an example, the IntraTMP prediction block within the CTU has its own type of classifier different to the multiple classifiers used in the intra prediction and the inter prediction. In an example, the IBC prediction block and the IntraTMP prediction block within the CTU have their own type of classifiers different from the multiple classifiers used in the intra prediction and the inter prediction. In an example, the number of classifiers of the multiple classifiers is reduced to 1 when a number of the sample for the intra prediction, the IBC prediction, the IntraTMP prediction, or the inter prediction within the CTU is less than and/or equal to a predefined value thr. In an example, the maximum number of the classifiers for the multiple classifiers is determined by a total number of the intra prediction samples, the IBC prediction samples, the IntraTMP prediction samples, the inter prediction samples, and/or the like within the coding block or the CTU. A different total number may have a different allowed maximum number of the classifiers.

In an example, different classes of a classifier (e.g., the direction and variance based classifier) are used for luma samples obtained with different prediction modes. For example, inter luma samples (also referred to as inter predicted luma samples) have corresponding first classes, and intra luma samples (also referred to as intra predicted luma samples) have corresponding second classes. The first classes and the second classes are different from each other. In this case, the first 25 classes are used for the inter predicted luma samples and the second 25 classes are used for the intra predicted luma samples when the direction and variance based classification is used. In an example, the intra block copy (IBC) prediction block within the CTU has its own type of class different from the multiple classes used in the intra prediction and the inter prediction. In an example, the intra template-matching (IntraTMP) prediction block within the CTU has its own type of class different to the multiple classes used in the intra prediction and the inter prediction. In an example, the IBC prediction block and the IntraTMP prediction block within the CTU have their own type of class different from the multiple classes used in the intra prediction and the inter prediction. In an example, the number of classes of the multiple classes is reduced to 1 when a number of the sample for the intra prediction, the IBC prediction, the IntraTMP prediction, or the inter prediction within the CTU is less than and/or equal to a predefined value thr. In an example, the maximum number of the classes for the multiple classes is determined by a total number of the intra prediction samples, the IBC prediction samples, the IntraTMP prediction samples, the inter prediction samples, and/or the like within the coding block or the CTU. A different total number may have a different allowed maximum number of the classes.

In an example, different prediction modes may have different filter shapes.

In an example, only one filter shape is used for multiple prediction modes (e.g., all prediction modes).

In an example, different kinds of classifiers are used for the model derivation, for example, in the CCF coefficient derivation module (803). In an example, the coded information includes a syntax element indicating the classifier in a plurality of classifiers (e.g., the different kinds of classifiers). In an example, the plurality of classifiers includes a direction-and-variance-based classifier (also referred to as the direction and variance based classifier) and a sample-value-based classifier (also referred to as the sample value based classifier). The syntax element is signaled to indicate which kind of classifier is to be used. For example, the direction and variance based classifier is applied when the syntax element is 0, and a sample value based classifier is to be chosen when the syntax element is 1.

In an example, the sample value based classifier for 2×2 samples is described in Eq. (15). In Eq. (15), sum is the sum of 2×2 sample values.

In an example, different kinds of classifier use an identical filter shape. For example, both of the direction and variance based classifier and the sample value based classifier use a 25-tap 9×9 filter shape.

In an example, different kinds of classifier may have different filter shapes. For example, a 25-tap 9×9 filter shape is used for the direction and variance based classifier, and a 7-tap filter shape left figure such as used in VVC is used for the sample value based classifier.

In an example, a merge process is applied to two adjacent classifiers (e.g., two adjacent classes of the direction and variance based classifier) during the filter coefficient derivation and a filter coefficient application.

In an example, the merge process in a luma ALF may be used for the merge process of the derivation method in the disclosure such as described in FIGS. 8-12.

In an example, the two adjacent classes for the merge process may be two adjacent directions with the same activity when the direction and variance based classifier is used.

In an example, the two adjacent classes for the merge process may be two adjacent activities with the same direction when the direction and variance based classifier is used.

In an example, the merge process of two adjacent classes for different prediction modes are independent.

In an example, the merge process is applied when the sample number of the associated classifier is less than and/or equal to a predefined threshold value τ. In an example, τ may be a fixed percentage of a CTU block size. For example, τ is equal to 1/32 of the CTU block size. In an example, τ may be k times of a number of filter coefficient tap, where k is a non-zero positive value. For example, τ is equal to 220 when the number of filter coefficient taps for each classifier is 20.

In an example, the derivation method described in the disclosure such as described in FIGS. 8-12 is a sub-mode of the cross-component filter. A flag of the derivation method is further signaled when the cross-component filter is applied. For example, the derivation method is a sub-mode of the CC-ALF. When the flag indicates that the CC-ALF is true, another flag is further signaled to indicate whether the derivation method with locally derived cross-component filtering models is used or not. If the other flag is true, the derivation method is applied such as described in FIGS. 8-12; otherwise, the signaled CC-ALF filter coefficients are used for the CC-ALF such as described in FIG. 5.

In an aspect, filter shapes and a number of taps for the derived CCF models may differ from those of other cross-component filters, and in some examples a subset of a CC-ALF shape is reused, for example, to improve implementation efficiency. In an example, the number of filter coefficients and/or the filter shapes used in the derivation method such as described in FIGS. 8-12 may be different from those in other related cross-component filters such as shown in FIG. 5. For example, there are up to 25 classes and 22 filter taps for each class in the derivation method such as shown in FIGS. 8-12, and only one class with 31 filter taps for the CC-ALF such as shown in FIG. 5.

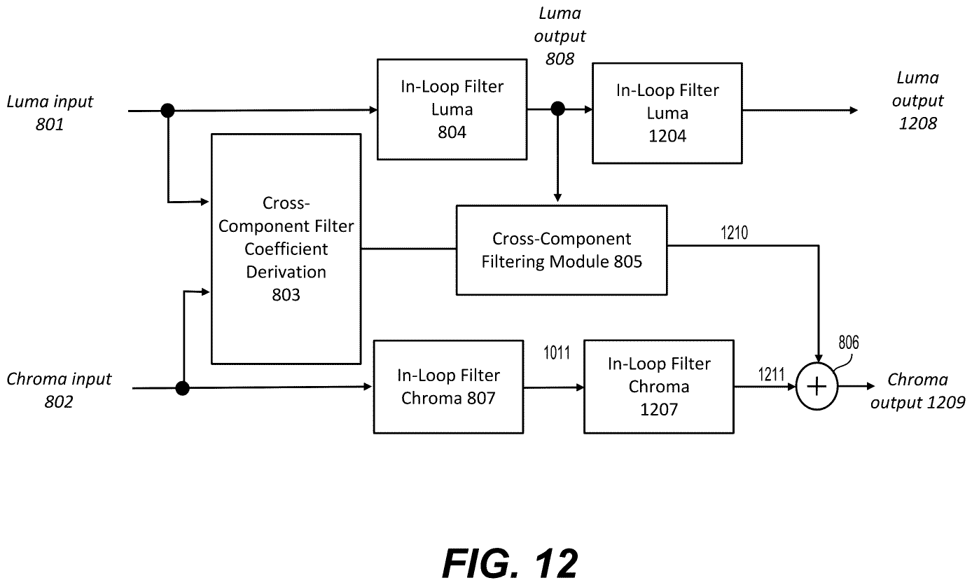

In an example, the derivation method may share a part of a filter shape of the related cross-component filter. FIG. 13 shows an example of a filter shape (1300) used in a CC-ALF according to an aspect of the disclosure. For example, the filter shape (1300) includes a 22-tap 9×9 filter shape (1301) that has a cross shape and a 5-tap 3×3 filter shape (1302) that has a cross shape. A part of the filter shape (1300), such as the 22-tap luma spatial filter shape (1301) or a part of the 22-tap luma spatial filter shape (1301), may be used in the derivation method such as described in FIGS. 8-12. In an example, the 22-tap luma spatial filter shape (1301) used in the CC-ALF such as described in FIG. 5 is used for the derivation method such as described in FIGS. 8-12. In an example, this 22-tap 9×9 filter shape (1301) is used for each classifier of the derivation method, and then 25 filter coefficient sets (or 25 CCF models) are derived in the CCF coefficient derivation module (803). Each filter coefficient set (e.g., a CCF model) has 22 filter coefficients and may be applied to a coding block or a CTU.

In an aspect, referring to FIG. 12, the cross-component filter coefficient derivation is derived by using the luma input (801) of the luma in-loop filter (804) and the chroma input (802) of the chroma in-loop filter (807) within a whole coding block or a CTU. In an example, the cross-component filter coefficient derivation is performed in the CCF coefficient derivation module (803). The derived filter coefficients may be applied to the luma input of the luma in-loop filter (1204) to obtain the output (e.g., the cross-component filtered value) (1210) for the chroma component. The luma input of the luma in-loop filter (1204) is also the luma output (808) of the luma in-loop filter (804).

In an example, referring to FIG. 12, the chroma output (1210) is a chroma sample offset value. Finally, the chroma sample offset value (1210) for each sample is added to the chroma output (1211) of the chroma in-loop filter (1207) to obtain the final chroma output value (1209) for the chroma component.

In an example, referring to FIG. 12, the cross-component filtered value (1210) is the chroma sample value and the chroma sample value is blended with the chroma output (1211) of chroma in-loop filter (1207) to obtain the final chroma output value (1209). In an example, the second chroma sample (1209) is obtained as follows: an intermediate chroma sample (1211) (e.g., the chroma output of chroma in-loop filter (1207)) is obtained by filtering the one of the first chroma samples (802) with a sequence of chroma in-loop filters (e.g., (807) and (1207)) and a weighted average of the cross-component filtered value (1210) and the intermediate chroma sample (1211) is determined as the second chroma sample (1209).

In an example, the input luma and chroma samples (801)-(802) for the cross-component filter coefficient derivation that is performed in the CCF coefficient derivation module (803) include the reconstructed samples before a deblocking filter.

In an example, the input luma and chroma samples (801)-(802) for the cross-component filter coefficient derivation that is performed in the CCF coefficient derivation module (803) include the reconstructed samples after the deblocking filter.

In an example, a flag is signaled to indicate whether the derivation method such as described in FIG. 12 is applied or not. If the flag is true, the derivation method such as described in FIG. 12 is applied to the output of the chroma in-loop filter (1207). Otherwise, the chroma output of the chroma in-loop filter (1207) remains unchanged and may be the second chroma sample (1209).

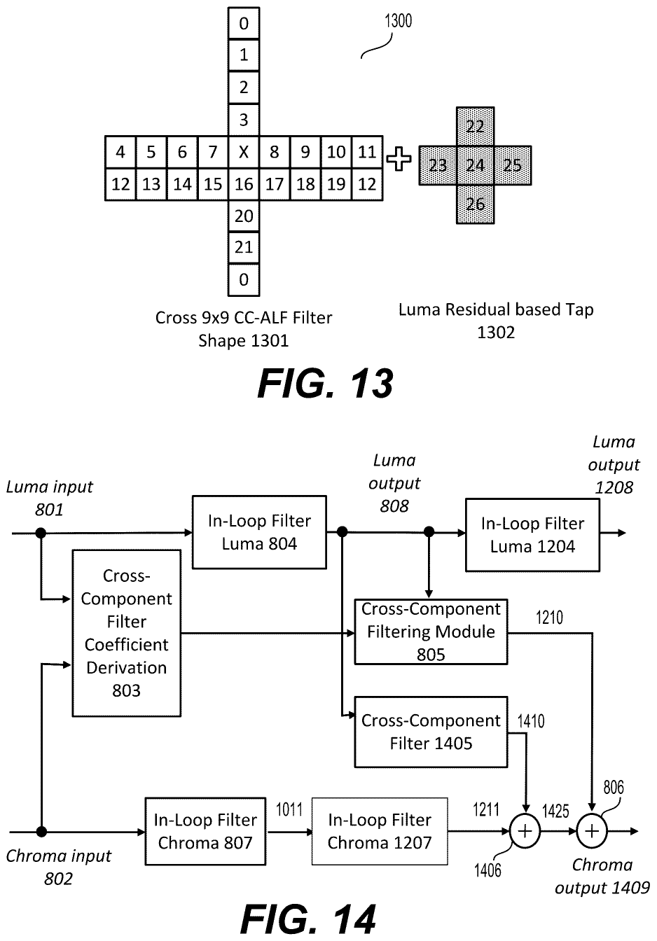

In an aspect, the locally derived cross-component filtering may operate in parallel with other cross-component filtering processes, with outputs combined to produce the final chroma sample, such as shown in FIG. 14. In an example, referring to FIG. 14, the derivation method is performed in parallel with other cross-component in-loop filtering. The cross-component filter coefficient derivation is performed by using the luma input (801) of the luma in-loop filter (804) and the chroma input (802) of the chroma in-loop filter (807) within a whole coding block or a CTU. In an example, the cross-component filter coefficient derivation is performed in the CCF coefficient derivation module (803). One of the one or more CCF models may be selected in the cross-component filtering module (805) based on the luma input of the luma in-loop filter (1204). The derived filter coefficients of the selected one of the one or more CCF models may be applied to the luma input of the luma in-loop filter (1204) to obtain the output (e.g., the cross-component filtered value) (1210) for the chroma component, for example, in the cross-component filtering module (805). The luma input of the luma in-loop filter (1204) is also the luma output (808) of the luma in-loop filter (804).

Further, a cross-component filter (1405) may be applied to the luma input of the luma in-loop filter (1204) to obtain an output (1410) for the chroma component. The inputs to the cross-component filter (1405) and the cross-component filtering module (805) are the same, e.g., the luma output (808), and the cross-component filter (1405) and the cross-component filtering module (805) may work in parallel to generate the outputs (1210) and (1410), respectively.

In an example, the chroma input (802) is filtered by one or more chroma in-loop filters (e.g., the chroma in-loop filters (807) and (1207)) to obtain the chroma output (1211). The output (1410) of the cross-component filter (1405) is added to the chroma output (1211) of the chroma in-loop filter (1207) by an adder (1406) to obtain a value (1425). The chroma sample offset value (1210) is added to the value (1425) to obtain the final chroma output value (e.g., the second chroma sample) (1409) for the chroma component.

In an example, referring to FIG. 14, the second chroma sample (1409) may be obtained as follows: the intermediate chroma sample (1211) is obtained by filtering the one of the first chroma samples (802) with one or more chroma in-loop filters (e.g., chroma in-loop filters (807) and (1207)), and a second cross-component filtering model (e.g., the cross-component filter (1405)) is applied to the second luma sample (808) to obtain the second cross-component filtered value (1410). In some examples, second filter coefficients of the second cross-component filtering model are signaled in the bitstream. The second chroma sample (1409) is determined based on the cross-component filtered value (1210), the second cross-component filtered value (1410), and the intermediate chroma sample (1211).

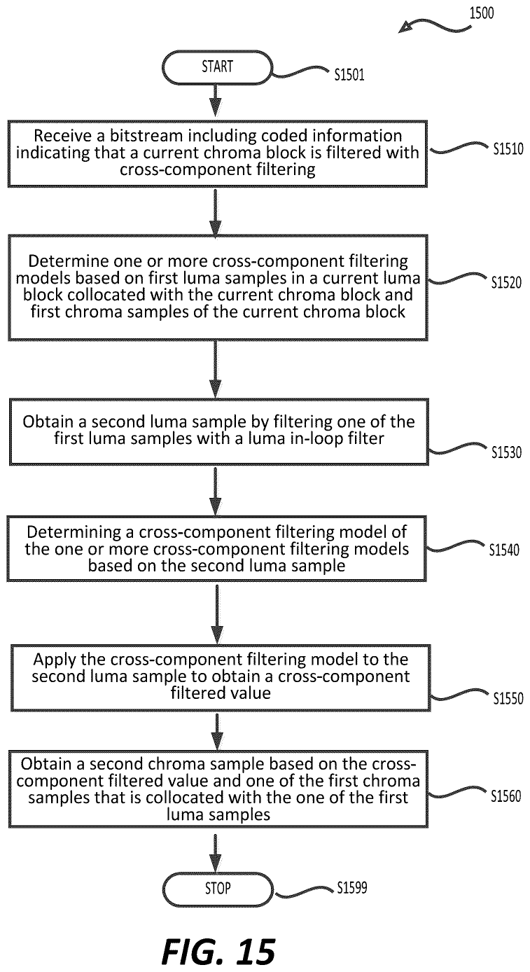

FIG. 15 shows a flow chart outlining a process (1500) according to an aspect of the disclosure. The process (1500) may be used in an apparatus, such as a video decoder. In various aspects, the process (1500) is executed by processing circuitry, such as the processing circuitry that performs functions of the video decoder (110), the processing circuitry that performs functions of the video decoder (210), and the like. In some aspects, the process (1500) is implemented in software instructions, thus when the processing circuitry executes the software instructions, the processing circuitry performs the process (1500). The process starts at (S1501) and proceeds to (S1510).

At (S1510), a bitstream is received that includes coded information indicating that a current chroma block is filtered using cross-component filtering.

At (S1520), one or more cross-component filtering models are determined based on first luma samples in a current luma block that is collocated with the current chroma block and on first chroma samples of the current chroma block.

In an example, the coded information includes a flag indicating that the one or more cross-component filtering models are determined based on the first luma samples in the current luma block and the first chroma samples of the current chroma block.

In an example, the first luma samples in the current luma block and the first chroma samples in the current chroma block are reconstructed samples that are to be filtered by a deblocking filter.

In an example, the first luma samples in the current luma block and the first chroma samples in the current chroma block are reconstructed samples that have been filtered by a deblocking filter.

In an example, the one or more cross-component filtering models are determined by classifying the first luma samples into one or more classes using a classifier. Each of the one or more classes corresponds to a respective cross-component filtering model of the one or more cross-component filtering models.

In an example, the one or more cross-component filtering models include a plurality of cross-component filtering models.

In an example, the classifier is one of a plurality of classifiers, and the classifier is associated with a prediction mode of the first luma samples.

In an example, the coded information includes a syntax element indicating the classifier in a plurality of classifiers that includes a direction-and-variance-based classifier and a sample-value-based classifier.

At (S1530), a second luma sample is obtained by filtering one of the first luma samples using a luma in-loop filter.

At (S1540), a cross-component filtering model among the one or more cross-component filtering models is determined based on the second luma sample.

In an example, the second luma sample is classified using the classifier into one of the one or more classes that corresponds to the cross-component filtering model.

At (S1550), the cross-component filtering model is applied to the second luma sample to obtain a cross-component filtered value.

At (S1560), a second chroma sample is obtained based on the cross-component filtered value and one of the first chroma samples that is collocated with the one of the first luma samples.

In an example, a weighted average of the cross-component filtered value and the one of the first chroma samples is determined, and the second chroma sample is obtained by filtering the weighted average using a chroma in-loop filter.

In an example, the cross-component filtered value is added to the one of the first chroma samples to obtain an intermediate chroma sample, and the second chroma sample is obtained by filtering the intermediate chroma sample using a chroma in-loop filter.

In an example, an intermediate chroma sample is obtained by filtering the one of the first chroma samples using a chroma in-loop filter, and a weighted average of the cross-component filtered value and the intermediate chroma sample is determined as the second chroma sample.

In an example, an intermediate chroma sample is obtained by filtering the one of the first chroma samples using a chroma in-loop filter, and the cross-component filtered value is added to the intermediate chroma sample to obtain the second chroma sample.

In an example, an intermediate chroma sample is obtained by filtering the one of the first chroma samples using a sequence of chroma in-loop filters, and the cross-component filtered value is added to the intermediate chroma sample such that the second chroma sample is a sum of the cross-component filtered value and the intermediate chroma sample.

In an example, an intermediate chroma sample is obtained by filtering the one of the first chroma samples using a sequence of chroma in-loop filters, and a weighted average of the cross-component filtered value and the intermediate chroma sample is determined as the second chroma sample.

In an example, an intermediate chroma sample is obtained by filtering the one of the first chroma samples using one or more chroma in-loop filters, and a second cross-component filtering model is applied to the second luma sample to obtain a second cross-component filtered value. Second filter coefficients of the second cross-component filtering model are signaled in the bitstream. The second chroma sample is determined based on the cross-component filtered value, the second cross-component filtered value, and the intermediate chroma sample.

Then, the process proceeds to (S1599) and terminates.

The process (1500) may be suitably adapted. Step(s) in the process (1500) may be modified and/or omitted. Additional step(s) may be added. Any suitable order of implementation may be used.

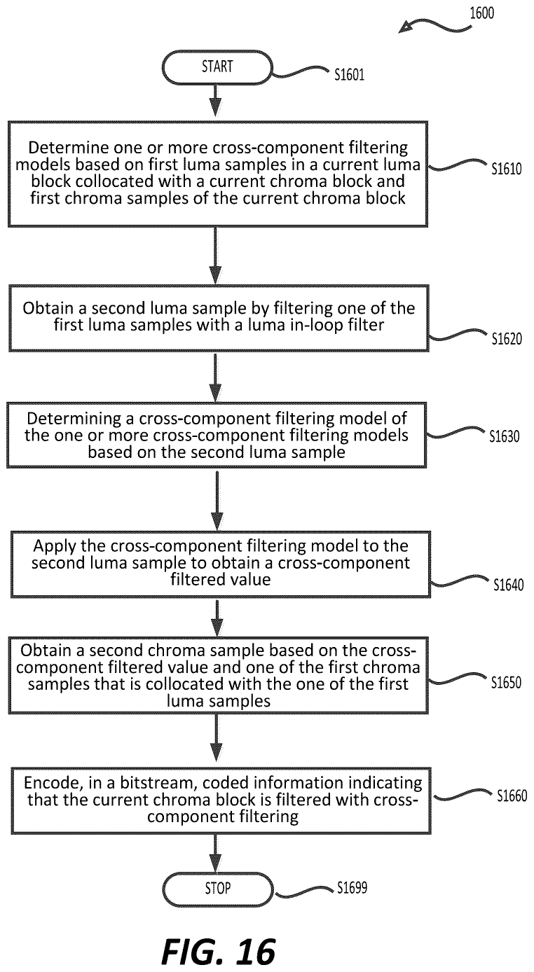

FIG. 16 shows a flow chart outlining a process (1600) according to an aspect of the disclosure. The process (1600) may be used in an apparatus. The apparatus may include a mesh encoder, such as a video encoder. The video encoder is configured to, for example, to encode one or more meshes. In various aspects, the process (1600) is executed by processing circuitry, such as the processing circuitry that performs functions of the video encoder (103), the processing circuitry that performs functions of the video encoder (303), the mesh encoder, and/or the like. In some aspects, the process (1600) is implemented in software instructions, thus when the processing circuitry executes the software instructions, the processing circuitry performs the process (1600). The process starts at (S1601) and proceeds to (S1610).

At (S1610), one or more cross-component filtering models are determined based on first luma samples in a current luma block that is collocated with a current chroma block and first chroma samples of the current chroma block.

In an example, the one or more cross-component filtering models are determined by classifying, with a classifier, the first luma samples into one or more classes, and each of the one or more classes corresponds to a respective cross-component filtering model of the one or more cross-component filtering models.

At (S1610), a second luma sample is obtained by filtering one of the first luma samples using a luma in-loop filter.

At (S1610), a cross-component filtering model among the one or more cross-component filtering models is determined based on the second luma sample.

At (S1610), the cross-component filtering model is applied to the second luma sample to obtain a cross-component filtered value.

At (S1610), a second chroma sample is obtained based on the cross-component filtered value and one of the first chroma samples that is collocated with the one of the first luma samples.

At (S1610), coded information indicating that the current chroma block is filtered using cross-component filtering is encoded in a bitstream

Then, the process proceeds to (S1699) and terminates.

The process (1600) may be suitably adapted. Step(s) in the process (1600) may be modified and/or omitted. Additional step(s) may be added. Any suitable order of implementation may be used.

In an aspect, a non-transitory computer-readable storage medium storing instructions which when executed by a processor cause the processor to perform an encoding method including: determining one or more cross-component filtering models based on first luma samples in a current luma block collocated with a current chroma block and first chroma samples of the current chroma block; obtaining a second luma sample by filtering one of the first luma samples with a luma in-loop filter; determining a cross-component filtering model of the one or more cross-component filtering models based on the second luma sample; applying the cross-component filtering model to the second luma sample to obtain a cross-component filtered value; obtaining a second chroma sample based on the cross-component filtered value and one of the first chroma samples that is collocated with the one of the first luma samples; encoding, in a bitstream, coded information indicating that the current chroma block is filtered with cross-component filtering; and transmitting the bitstream.

Methods, aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

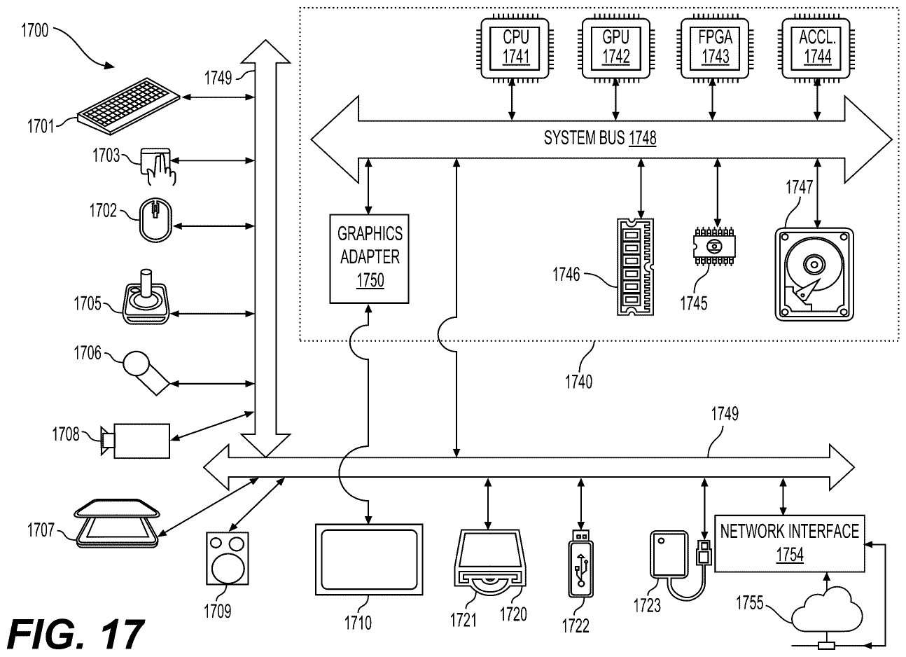

The techniques described above, may be implemented as computer software using computer-readable instructions and physically stored in one or more computer-readable media. For example, FIG. 17 shows a computer system (1700) suitable for implementing certain aspects of the disclosed subject matter.

The computer software may be coded using any suitable machine code or

computer language, that may be subject to assembly, compilation, linking, or like mechanisms to create code comprising instructions that may be executed directly, or through interpretation, micro-code execution, and the like, by one or more computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 17 for computer system (1700) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1700).

Computer system (1700) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1701), mouse (1702), trackpad (1703), touch screen (1710), data-glove (not shown), joystick (1705), microphone (1706), scanner (1707), camera (1708).

Computer system (1700) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1710), data-glove (not shown), or joystick (1705), but there may also be tactile feedback devices that do not serve as input devices), audio output devices (such as: speakers (1709), headphones (not depicted)), visual output devices (such as screens (1710) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1700) may also include human accessible storage devices and their associated media such as optical media including CD/DVD ROM/RW (1720) with CD/DVD or the like media (1721), thumb-drive (1722), removable hard drive or solid state drive (1723), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1700) may also include an interface (1754) to one or more communication networks (1755). Networks may for example be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1749) (such as, for example USB ports of the computer system (1700)); others are commonly integrated into the core of the computer system (1700) by attachment to a system bus as described below (for example Ethernet interface into a PC computer system or cellular network interface into a smartphone computer system). Using any of these networks, computer system (1700) may communicate with other entities. Such communication may be uni-directional, receive only (for example, broadcast TV), uni-directional send-only (for example CANbus to certain CANbus devices), or bi-directional, for example to other computer systems using local or wide area digital networks. Certain protocols and protocol stacks may be used on each of those networks and network interfaces as described above.

Aforementioned human interface devices, human-accessible storage devices, and network interfaces may be attached to a core (1740) of the computer system (1700).

The core (1740) may include one or more Central Processing Units (CPU) (1741), Graphics Processing Units (GPU) (1742), specialized programmable processing units in the form of Field Programmable Gate Areas (FPGA) (1743), hardware accelerators for certain tasks (1744), graphics adapters (1750), and so forth. These devices, along with Read-only memory (ROM) (1745), Random-access memory (1746), internal mass storage such as internal non-user accessible hard drives, SSDs, and the like (1747), may be connected through a system bus (1748). In some computer systems, the system bus (1748) may be accessible in the form of one or more physical plugs to enable extensions by additional CPUs, GPU, and the like. The peripheral devices may be attached either directly to the core's system bus (1748), or through a peripheral bus (1749). In an example, the screen (1710) may be connected to the graphics adapter (1750). Architectures for a peripheral bus include PCI, USB, and the like.

CPUs (1741), GPUs (1742), FPGAs (1743), and accelerators (1744) may execute certain instructions that, in combination, may make up the aforementioned computer code. That computer code may be stored in ROM (1745) or RAM (1746). Transitional data may also be stored in RAM (1746), whereas permanent data may be stored for example, in the internal mass storage (1747). Fast storage and retrieve to any of the memory devices may be enabled through the use of cache memory, that may be closely associated with one or more CPU (1741), GPU (1742), mass storage (1747), ROM (1745), RAM (1746), and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture (1700), and specifically the core (1740) may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core (1740) that are of non-transitory nature, such as core-internal mass storage (1747) or ROM (1745). The software implementing various aspects of the present disclosure may be stored in such devices and executed by core (1740). A computer-readable medium may include one or more memory devices or chips, according to particular needs. The software may cause the core (1740) and specifically the processors therein (including CPU, GPU, FPGA, and the like) to execute particular processes or particular parts of particular processes described herein, including defining data structures stored in RAM (1746) and modifying such data structures according to the processes defined by the software. In addition or as an alternative, the computer system may provide functionality as a result of logic hardwired or otherwise embodied in a circuit (for example: accelerator (1744)), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method for video decoding, the method including: receiving a bitstream including coded information indicating that a current chroma block is filtered with cross-component filtering; determining one or more cross-component filtering models based on first luma samples in a current luma block collocated with the current chroma block and first chroma samples of the current chroma block; obtaining a second luma sample by filtering one of the first luma samples with a luma in-loop filter; determining a cross-component filtering model of the one or more cross-component filtering models based on the second luma sample; applying the cross-component filtering model to the second luma sample to obtain a cross-component filtered value; and obtaining a second chroma sample based on the cross-component filtered value and one of the first chroma samples that is collocated with the one of the first luma samples.
(2) The method of feature (1), in which the determining the one or more cross-component filtering models includes: determining the one or more cross-component filtering models by classifying with a classifier the first luma samples into one or more classes, each of the one or more classes corresponding to a respective cross-component filtering model of the one or more cross-component filtering models.
(3) The method of feature (2), in which the determining the cross-component filtering model includes classifying with the classifier the second luma sample into one of the one or more classes that corresponds to the cross-component filtering model.
(4) The method of feature (1) or (2), in which the one or more cross-component filtering models include a plurality of cross-component filtering models.
(5) The method of feature (2), in which the classifier is one of a plurality of classifiers, and the classifier is associated with a prediction mode of the first luma samples.
(6) The method of feature (2), in which the coded information includes a syntax element indicating the classifier in a plurality of classifiers.
(7) The method of feature (6), in which the plurality of classifiers includes a direction-and-variance-based classifier and a sample-value-based classifier.
(8) The method of any of features (1) to (3), in which the obtaining the second chroma sample includes determining a weighted average of the cross-component filtered value and the one of the first chroma samples; and obtaining the second chroma sample by filtering the weighted average with a chroma in-loop filter.
(9) The method of any of features (1) to (3), in which the obtaining the second chroma sample includes: adding the cross-component filtered value to the one of the first chroma samples to obtain an intermediate chroma sample; and obtaining the second chroma sample by filtering the intermediate chroma sample with a chroma in-loop filter.
(10) The method of any of features (1) to (3), in which the obtaining the second chroma sample includes obtaining an intermediate chroma sample by filtering the one of the first chroma samples with a chroma in-loop filter; and determining a weighted average of the cross-component filtered value and the intermediate chroma sample as the second chroma sample.
(11) The method of any of features (1) to (3), in which the obtaining the second chroma sample includes: obtaining an intermediate chroma sample by filtering the one of the first chroma samples with a chroma in-loop filter; and adding the cross-component filtered value to the intermediate chroma sample to obtain the second chroma sample.
(12) The method of any of features (1) to (3), in which the obtaining the second chroma sample includes: obtaining an intermediate chroma sample by filtering the one of the first chroma samples with a sequence of chroma in-loop filters; and adding the cross-component filtered value to the intermediate chroma sample, the second chroma sample being a sum of the cross-component filtered value and the intermediate chroma sample.
(13) The method of any of features (1) to (3), in which the coded information includes a flag indicating that the one or more cross-component filtering models are determined based on the first luma samples in the current luma block and the first chroma samples of the current chroma block.
(14) The method of any of features (1) to (3), in which the obtaining the second chroma sample includes: obtaining an intermediate chroma sample by filtering the one of the first chroma samples with a sequence of chroma in-loop filters; and determining a weighted average of the cross-component filtered value and the intermediate chroma sample as the second chroma sample.
(15) The method of any of features (1) to (3), in which the first luma samples in the current luma block and the first chroma samples in the current chroma block are reconstructed samples that are to be filtered by a deblocking filter.
(16) The method of any of features (1) to (3), in which the first luma samples in the current luma block and the first chroma samples in the current chroma block are reconstructed samples that have been filtered by a deblocking filter.
(17) The method of any of features (1) to (3), in which the obtaining the second chroma sample includes: obtaining an intermediate chroma sample by filtering the one of the first chroma samples with one or more chroma in-loop filters; applying a second cross-component filtering model to the second luma sample to obtain a second cross-component filtered value, second filter coefficients of the second cross-component filtering model being signaled in the bitstream; and determining the second chroma sample based on the cross-component filtered value, the second cross-component filtered value, and the intermediate chroma sample.
(18) A method for video encoding, the method including: determining one or more cross-component filtering models based on first luma samples in a current luma block collocated with a current chroma block and first chroma samples of the current chroma block; obtaining a second luma sample by filtering one of the first luma samples with a luma in-loop filter; determining a cross-component filtering model of the one or more cross-component filtering models based on the second luma sample; applying the cross-component filtering model to the second luma sample to obtain a cross-component filtered value; obtaining a second chroma sample based on the cross-component filtered value and one of the first chroma samples that is collocated with the one of the first luma samples; and encoding, in a bitstream, coded information indicating that the current chroma block is filtered with cross-component filtering.
(19) The method of feature (18), in which the determining the one or more cross-component filtering models includes: determining the one or more cross-component filtering models by classifying with a classifier the first luma samples into one or more classes, each of the one or more classes corresponding to a respective cross-component filtering model of the one or more cross-component filtering models.
(20) A non-transitory computer-readable storage medium storing instructions which when executed by a processor cause the processor to perform an encoding method including: determining one or more cross-component filtering models based on first luma samples in a current luma block collocated with a current chroma block and first chroma samples of the current chroma block; obtaining a second luma sample by filtering one of the first luma samples with a luma in-loop filter; determining a cross-component filtering model of the one or more cross-component filtering models based on the second luma sample; applying the cross-component filtering model to the second luma sample to obtain a cross-component filtered value; obtaining a second chroma sample based on the cross-component filtered value and one of the first chroma samples that is collocated with the one of the first luma samples; encoding, in a bitstream, coded information indicating that the current chroma block is filtered with cross-component filtering; and transmitting the bitstream.
(21) An apparatus of video decoding, including processing circuitry that is configured to perform the method of any of features (1) to (17).
(22) An apparatus of video encoding, including processing circuitry that is configured to perform the method of any of features (18) to (19).
(23) A non-transitory computer-readable storage medium storing instructions which when executed by at least one processor cause the at least one processor to perform the method of any of features (1) to (19).

What is claimed is:

1. A method for video decoding, the method comprising:
receiving a bitstream including coded information indicating that a current chroma block is filtered with cross-component filtering;
determining one or more cross-component filtering models based on first luma samples in a current luma block collocated with the current chroma block and first chroma samples of the current chroma block;
obtaining a second luma sample by filtering one of the first luma samples with a luma in-loop filter;
determining a cross-component filtering model of the one or more cross-component filtering models based on the second luma sample;
applying the cross-component filtering model to the second luma sample to obtain a cross-component filtered value; and
obtaining a second chroma sample based on the cross-component filtered value and one of the first chroma samples that is collocated with the one of the first luma samples.

2. The method of claim 1, wherein the determining the one or more cross-component filtering models comprises:
determining the one or more cross-component filtering models by classifying with a classifier the first luma samples into one or more classes, each of the one or more classes corresponding to a respective cross-component filtering model of the one or more cross-component filtering models.

3. The method of claim 2, wherein the determining the cross-component filtering model comprises:
classifying with the classifier the second luma sample into one of the one or more classes that corresponds to the cross-component filtering model.

4. The method of claim 2, wherein the one or more cross-component filtering models include a plurality of cross-component filtering models.

5. The method of claim 2, wherein the classifier is one of a plurality of classifiers, and the classifier is associated with a prediction mode of the first luma samples.

6. The method of claim 2, wherein the coded information includes a syntax element indicating the classifier in a plurality of classifiers.

7. The method of claim 6, wherein the plurality of classifiers includes a direction-and-variance-based classifier and a sample-value-based classifier.

8. The method of claim 1, wherein the obtaining the second chroma sample comprises:
determining a weighted average of the cross-component filtered value and the one of the first chroma samples; and
obtaining the second chroma sample by filtering the weighted average with a chroma in-loop filter.

9. The method of claim 1, wherein the obtaining the second chroma sample comprises:
adding the cross-component filtered value to the one of the first chroma samples to obtain an intermediate chroma sample; and
obtaining the second chroma sample by filtering the intermediate chroma sample with a chroma in-loop filter.

10. The method of claim 1, wherein the obtaining the second chroma sample comprises:
obtaining an intermediate chroma sample by filtering the one of the first chroma samples with a chroma in-loop filter; and
determining a weighted average of the cross-component filtered value and the intermediate chroma sample as the second chroma sample.

11. The method of claim 1, wherein the obtaining the second chroma sample comprises:
obtaining an intermediate chroma sample by filtering the one of the first chroma samples with a chroma in-loop filter; and
adding the cross-component filtered value to the intermediate chroma sample to obtain the second chroma sample.

12. The method of claim 1, wherein the obtaining the second chroma sample comprises:
obtaining an intermediate chroma sample by filtering the one of the first chroma samples with a sequence of chroma in-loop filters; and
adding the cross-component filtered value to the intermediate chroma sample, the second chroma sample being a sum of the cross-component filtered value and the intermediate chroma sample.

13. The method of claim 1, wherein the coded information includes a flag indicating that the one or more cross-component filtering models are determined based on the first luma samples in the current luma block and the first chroma samples of the current chroma block.

14. The method of claim 1, wherein the obtaining the second chroma sample comprises:
obtaining an intermediate chroma sample by filtering the one of the first chroma samples with a sequence of chroma in-loop filters; and
determining a weighted average of the cross-component filtered value and the intermediate chroma sample as the second chroma sample.

15. The method of claim 1, wherein the first luma samples in the current luma block and the first chroma samples in the current chroma block are reconstructed samples that are to be filtered by a deblocking filter.

16. The method of claim 1, wherein the first luma samples in the current luma block and the first chroma samples in the current chroma block are reconstructed samples that have been filtered by a deblocking filter.

17. The method of claim 1, wherein the obtaining the second chroma sample comprises:
obtaining an intermediate chroma sample by filtering the one of the first chroma samples with one or more chroma in-loop filters;
applying a second cross-component filtering model to the second luma sample to obtain a second cross-component filtered value, second filter coefficients of the second cross-component filtering model being signaled in the bitstream; and
determining the second chroma sample based on the cross-component filtered value, the second cross-component filtered value, and the intermediate chroma sample.

18. A method for video encoding, the method comprising:
determining one or more cross-component filtering models based on first luma samples in a current luma block collocated with a current chroma block and first chroma samples of the current chroma block;
obtaining a second luma sample by filtering one of the first luma samples with a luma in-loop filter;
determining a cross-component filtering model of the one or more cross-component filtering models based on the second luma sample;
applying the cross-component filtering model to the second luma sample to obtain a cross-component filtered value;
obtaining a second chroma sample based on the cross-component filtered value and one of the first chroma samples that is collocated with the one of the first luma samples; and
encoding, in a bitstream, coded information indicating that the current chroma block is filtered with cross-component filtering.

19. The method of claim 18, wherein the determining the one or more cross-component filtering models comprises:
determining the one or more cross-component filtering models by classifying with a classifier the first luma samples into one or more classes, each of the one or more classes corresponding to a respective cross-component filtering model of the one or more cross-component filtering models.

20. A non-transitory computer-readable storage medium storing instructions which when executed by a processor cause the processor to perform a method of encoding a bitstream comprising:
determining one or more cross-component filtering models based on first luma samples in a current luma block collocated with a current chroma block and first chroma samples of the current chroma block;
obtaining a second luma sample by filtering one of the first luma samples with a luma in-loop filter;
determining a cross-component filtering model of the one or more cross-component filtering models based on the second luma sample;
applying the cross-component filtering model to the second luma sample to obtain a cross-component filtered value;
obtaining a second chroma sample based on the cross-component filtered value and one of the first chroma samples that is collocated with the one of the first luma samples;
encoding, in the bitstream, coded information indicating that the current chroma block is filtered with cross-component filtering; and
transmitting the bitstream.
